(19) United States
(12) Patent Application Publication
(10) Pub. No.: US 2019/0309888 A1
(43) Pub. Date: Oct. 10, 2019

(54) Thread Protector

(71) Applicant: FabTech Services, LP, Rockwall, TX (US)

(72) Inventors: Chad J. Klodner, Sachse, TX (US); Jason M. Streber, McKinney, TX (US); Gregory A. Stanberry, Wylie, TX (US)

(21) Appl. No.: 15/945,088

(22) Filed: Apr. 4, 2018

(51) Int. Cl. F16L 57/00; B65D 59/06; B65D 59/02

(52) U.S. Cl. CPC F16L 57/005; F16L 15/08; B65D 59/02; B65D 59/06

(57) ABSTRACT

An apparatus and method for protecting exposed threads of a material. The apparatus having a base, a body with at least one open end, and at least one protrusion. The protrusions may be spaced evenly along an inner or outer surface of the apparatus body at a fixed distance from the base. Additionally, the protrusions can be matched to a thread pattern to allow for quick attachment, or connection. The apparatus may be constructed of a metallic material or alloy, or a combination of metallic materials and alloys. The thread protector thread pattern can then be matched to the thread pattern on the material or item to be protected. Affixing the thread protector to the material or item to be protected could include turning the thread protector in a manner that secures, connects, or locks the protrusions with the thread patter of the material or item to be protected.

### BACKGROUND

### Technical Field

The present disclosure relates to a thread protector. More particularly, and not by way of limitation, the present disclosure is directed to an apparatus and method for an internal or external thread protector.

### Description of Related Art

In the field of pipefitting and pipe manufacturing there has been a need for something that would protect the threads of the pipes or vessels during transport. This especially true for those pipes or vessels used to transport explosives, which must be enclosed or encased. The Pipeline and Hazardous Materials and Safety Administration (PHMSA), within the U.S. Department of Transportation (DOT), has regulatory and civil enforcement authority over the transportation of explosive materials in commerce. The Hazardous Materials Regulations (HMR; 49 CFR Parts 171-180) applicable to packing method US 1 (1) (c) from the Table of Packing Methods in § 173.62 for jet perforating guns, charged, requires that, “each shaped charge if not completely enclosed in glass or metal, must be fully protected by a metal cover after installation in the gun.” Letters of Interpretation 16-0186 and more recently 17-0043 were published by PHMSA in response to requests to provide clarification of US1 (1) (c). These Letters of Interpretation confirm that each shaped charge must be protected by a metal or glass cover.

For example, the regulation require perforation guns in transport to have covers made of metal to be used in association with perforation or shape charges. A perforation charge is required by law to be enclosed in glass or metal. See 49 C.F.R. § 173.62. Additionally, if in transport it is required that the shape charges in a perforation gun be individually covered, and/or enclosed within the perforation gun by metal covers. Although plastic covers and plugs have been used extensively to cover male and female fittings in the past, the plastic covers apparently do not meet Department of Transportation (“DOT”) regulations.

The plastic covers and/or plugs may have metal enclosed or infused within them but they apparently still do not meet with DOT regulations according to interpretations made by the DOT. In addition, these plastic covers and plugs require a significant amount of time to install for each device. Prior art plastic covers and/or plugs have full thread patterns, meaning that not only are these plastic covers expensive to make, but they can also require significant amounts of time to fully install as the full thread pattern must be engaged with the material to be protected. The plastic covers or plugs apparently must then be enclosed or encased in metal or glass to meet with DOT regulations thereby increasing the costs yet again.

Therefore, it can be seen that there is a need in the industry for metal protective covers, plugs, and/or enclosures that are easy to manufacture and install. However, the use of a full thread pattern with protective covers, plugs, and/or enclosures is cost prohibitive as the tools required to cut or form a full thread pattern are expensive, and require significant time to produce a full thread pattern. A full thread pattern is typically cut or machined into the part through a process, which utilizes a cutting tool to remove material in a helical pattern (thread). Although, threads can be formed into a metal cover or plug, the process to form a full thread pattern, or a full series of thread patterns, requires complex tooling and additional time to remove the part after the thread pattern is created, thus creating additional manufacturing expense.

Moreover, a full thread pattern requires many turns to install, and with some pipes and/or vessels having openings as big as, and/or exceeding 10 inches in diameter, the installation time for even a few pipes or vessels can be very time consuming. In addition, metals such as steel are prone to galling and/or creating a spark that could then be an ignition source for any transported explosives. Additionally, a part that has a full thread pattern is also at an increased risk of galling the mating surface due to a cross threading or mismatched thread pattern. Attempts have been made to solve the problem by adding metal to typical plastic covers, but these apparently do not satisfy the DOT's interpretations of the regulations.

It would be advantageous to have an apparatus and method for thread protection that overcomes the disadvantages of the prior art. The present invention provides such an apparatus and method.

### BRIEF SUMMARY

The present invention is directed to a protective end piece with minimal profile protrusions that are matched to a part thread pattern.

Thus, in one aspect, the present invention is directed to a metal protective end cap or plug that will minimize the risk of galling or cross threading. With minimal profile protrusions that are matched to a part thread pattern, the likelihood of a galling or cross-threading is reduced.

In another aspect, the present invention is directed to a thread protector that eliminates the need for the expensive and costly machines and manufacturing equipment required to create or form a more complex protective end cap or plug.

In yet another aspect, the present invention is directed to a protective end cap or plug that can by quickly installed on a threaded pipe or fitting.

### BRIEF DESCRIPTION OF THE DRAWINGS

The novel features believed characteristic of the disclosure are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 illustrates a perspective view of a protective end plug in accordance with an embodiment of the invention.

FIG. 2 illustrates a top view of a protective end plug in accordance with an embodiment of the invention.

FIG. 3A illustrates a side view of a protective end plug in accordance with an embodiment of the invention.

FIG. 3B illustrates an exploded side view of the protrusions of a protective end plug or cap in accordance with an embodiment of the invention.

FIG. 4 illustrates a perspective view of a protective end cap in accordance with an embodiment of the invention.

FIG. 5 illustrates a top view of a protective end cap in accordance with an embodiment of the invention.

FIG. 6A illustrates a side view of a protective end cap in accordance with an embodiment of the invention.

FIG. 6B illustrates an exploded side view of the protrusions of a protective end cap in accordance with an embodiment of the invention.

FIG. 7 illustrates a flow chart of a method of use for at least one embodiment of the present invention.

FIG. 8A illustrates a thread protector plug and/or a thread protector cap engaging with a material to be protected.

FIG. 8B illustrates a thread protector plug and/or a thread protector cap engaging with a material to be protected.

### DETAILED DESCRIPTION

One embodiment of the invention will now be described. The description and illustrations are made in regards to a gravitational vector, and should not be limited to any vectors or reference plane.

The present disclosure describes a thread protector plug or cap that can be utilized in a number of environments or with various parts. In one embodiment of the present disclosure the thread protector plug or cap may be made or manufactured from a metal or metallic material. However, it would be understood that in alternative embodiments other materials such as, glass, plastics, rubber, synthetic rubber, silicone, synthetic composites, composites, metallic alloys, metals, wood, or combinations thereof would be available to manufacture or make the thread protector plug or cap.

While generally described as a cylindrical shape or profile, the thread protector plug and/or cap, it would be understood that any shape or profile could be utilized to enclose, cover, and/or protect a material. It would also be understood that the thread protector could be hollow or solid, with regards to its shape or profile. To engage with a thread pattern of a material to be protected, the thread protector plug and/or cap can have multiple protrusions along the inner or outer perimeter of the thread protector plug and/or cap. These protrusions may be formed and/or manufactured to match specific patterns or be formed and/or manufactured to generally match multiple thread patterns. In one embodiment of the present disclosure, a thread protector plug and/or cap could have multiple sets of protrusions, can be an internal and/or external set of protrusions, that may allow the thread protector to be reversible and/or utilized as both a cap and/or a plug. References to external threads can also be referred to as male thread patterns (i.e., the thread pattern of a bolt), and internal thread patterns can also be referred to as female thread patterns (i.e., the thread pattern of a nut).

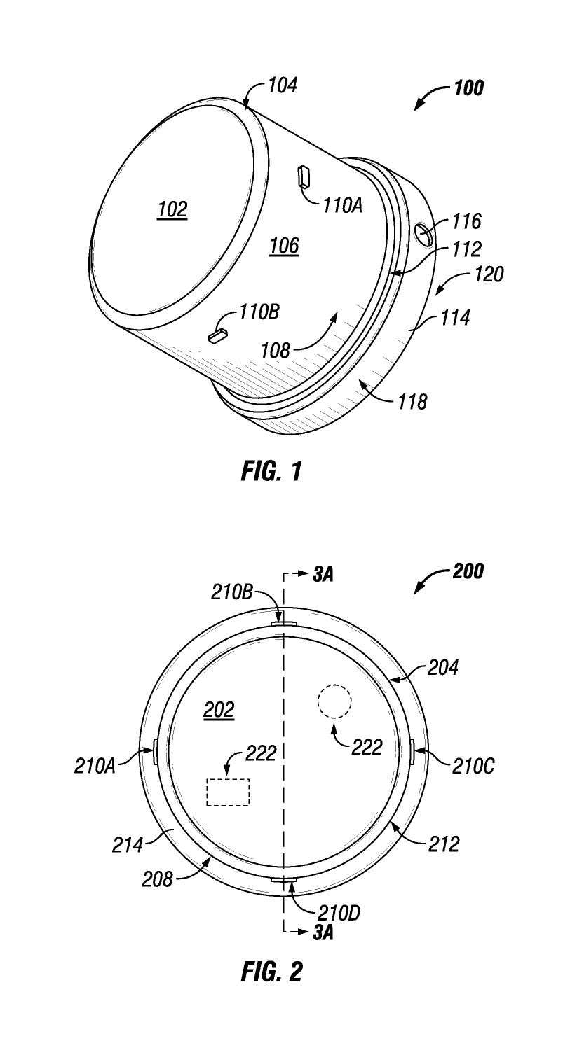

FIG. 1 illustrates a perspective view of a thread protector plug 100. The thread protector plug 100 can have a base 102 that may in one embodiment be formed during a forming or manufacturing process. The base 102 may be circular in profile or shape, but may also include a square, sphere, cylinders, polygons, ellipses, crescents, cubes, cuboids, ellipsoids, cones, prisms, pyramids, or combinations thereof. In alternative embodiments of the present disclosure, the base 102 may be welded, manufactured, or formed with a rounded edge 104. However, the base 102 may also be directly connected, manufactured, or formed with a wall or vertical wall 106. Alternatively, the base 102 may be connected to the wall or vertical wall 106 through the rounded edge 104, or some other edge or connector, such as, but not limited to, a square, a sharp edge, a decorative edge, or any combination thereof. In some embodiments of the present disclosure, the wall or vertical wall may also be a hollow cylinder. The wall or vertical wall can have an outer surface 108 that allows for an interface with a part or other internal thread pattern. The outer surface 108 can have multiple protrusions 110A, and/or 110B (collectively 110). The protrusions 110 can have a specific length, height, angle, and/or width to match different thread patterns or part connections. The thread pattern may have, but is not limited to, a right or left handed thread, a form or cross sectional shape, a specific thread angle, a specific lead, pitch or number of starts. Additionally, the protrusions 110 may be placed in specific locations along the outer surface 108 to provide for a specific depth or length of protection and may be placed to minimize the number of turns required to install the protective plugs. The number of turns required can be varied based on fitting size and desired depth of protection. The number of turns required to install the cap or plug until it is fully seated against the end-piece is controlled by the protrusions furthest from the end-piece or material to be protected.

The thread protector cap and/or plug, may in one embodiment be manufactured, made, or formed by a progressive stamping or progressive printing or tooling process. Upwards of ten (10) caps and/or plug may be manufactured, made, and/or formed with each action of the stamping process, with at least one cap or plug being completed with each action. The progressive stamping or progressive printing or tooling process can also include a die or stamping action for at least one protrusions, and/or as many as desired.

For example, the protrusions 110 can be created with a set of 4 protrusions that are placed evenly along the outer surface 108. Alternatively, the protrusions may be as few as one and/or as many as desired. For a circular thread protector plug 100, the protrusions 110 may be distributed evenly along the circumference of the circular thread protector plug 110 at a fixed distance from the base 102. The fixed distance may vary for each of the 4 protrusions in order to match a desired thread pattern, allowing the thread protector plug 100 to be inserted into many different numbers of devices. In alternative embodiments of the present disclosure, the vertical wall(s) or wall may be set at a relative angle of 90 degrees from the base. However, it would be understood, that in other embodiments of the present disclosure, the angle of the vertical wall or walls could be as great as 135 degrees relative to the base or as small as 45 degrees relative to the base as need for a specific application.

The vertical wall 106 can be connected by a connecting ring 112 to a retainer ring 114. It would be understood that the connecting ring 112 could be formed with the base, and/or vertical wall as a single piece of material, or may be manufactured separately. In alternative embodiments of the present disclosure, the connecting ring 112 could be a welded or manufactured seam attached through an adhesion product, process, or method. It would be understood that an adhesion product, process, or method, could include, but is not limited to, welding, tacking, fasteners, screws, nails, glue, adhesives, hook and loop, epoxy, two-part epoxy, bolts, nuts, or any combination thereof. The retainer ring 114 may also be directly attached, formed or manufactured simultaneously with the vertical wall 106. Additionally, the retainer ring 114 can have an outer ring surface 118, that may be utilized for through holes 116, or other retaining or fastening mechanisms. The vertical wall 106 can also create a hollow void, or opening 120 at one end, with the other end being enclosed by the base 102, and/or wall or vertical walls 106. The retainer ring, and/or container ring can allow for an o-ring, seal, or other weather tight sealing method to be utilized. In one embodiment of the present disclosure, the connecting ring 112, can include an o-ring and/or weather tight seal.

FIG. 2 illustrates a top view of a thread protector plug 200. The thread protector plug 200 can have a base 202. The base 202, as well as the thread protector plug 200 may be made of a metal material such as, but not limited to, aluminum, steel, iron, nickel based alloys, other metallic alloys, and/or combinations thereof. The metal material would in one embodiment be thick enough to contain an explosive force. In alternative embodiments, the metal material may be of a sufficient thickness to contain an explosive force below a threshold force, and upon the explosive force exceeding that value the metal material would be allowed to vent through vents 222. In other alternative embodiments, the metal material could be made of one material, while the vent could be made of another material with a lower melt or thermal coefficient temperature. For example, the second material for the vent could be made to melt at a temperature of 200 degrees Fahrenheit or some other temperature value and/or level. Thus, the vent and/or the vent material could be utilized to protect the material to be protected or enclosed from an open flame, a specific temperature value or level, and/or weather conditions. Alternatively, the vent and other metal material could fail at a specific threshold condition and/or temperature in order to relieve pressure or prevent a buildup of gas or pressure. In other embodiments of the present disclosure, the thread protector plug may be utilized to enclose a pipe, perforation gun, a shape charge opening, and/or a shape charge carrier.

The base 202 can be connected with an outer surface 208 through a rounded edge 204. The rounded edge 204 may be created during the forming or manufacture of the thread protector plug 200 or through an attachment or connection process or method such as, but not limited to, welding, adhesives, fasteners, and/or other attachment means. It should be noted that the outer surface 208 can be the outer surface of at least one wall or vertical wall (not shown), and any references to the outer surface 208 could include the wall or vertical wall as well. The outer surface 208 can also be connected to a retainer ring 214, through a containment ring 212. The containment ring 212 may be created during the forming or manufacture of the thread protector plug 200 or through an attachment or connection process or method such as, but not limited to, welding, adhesives, fasteners, and/or other attachment means.

The outer surface 208 can also have multiple protrusions 210A, 210B, 210C, 210D (collectively 210) extending outwardly. The protrusions 210 can be evenly spaced along the perimeter or in one embodiment the circumference of the thread protector 208. It would be understood that as few as one protrusion or as many as desired or may fit onto the outer surface 208 can be utilized. These protrusions could include various shapes, cross sections, profiles, and could be structured or modified to include a specific length, height, angle, and/or width to match different thread patterns or part connections. The thread pattern may have, but is not limited to, a right or left handed thread, a form or cross sectional shape, a specific thread angle, a specific lead, pitch, or number of starts. Additionally, the protrusions 210 may be placed in specific locations along the outer surface 208 to provide for a specific depth or length of protection. Placing the protrusion closer to the containment ring 212 can result in fewer number of turns to reach full engagement of the retaining ring 214 against an end of female threads to be protected or covered.

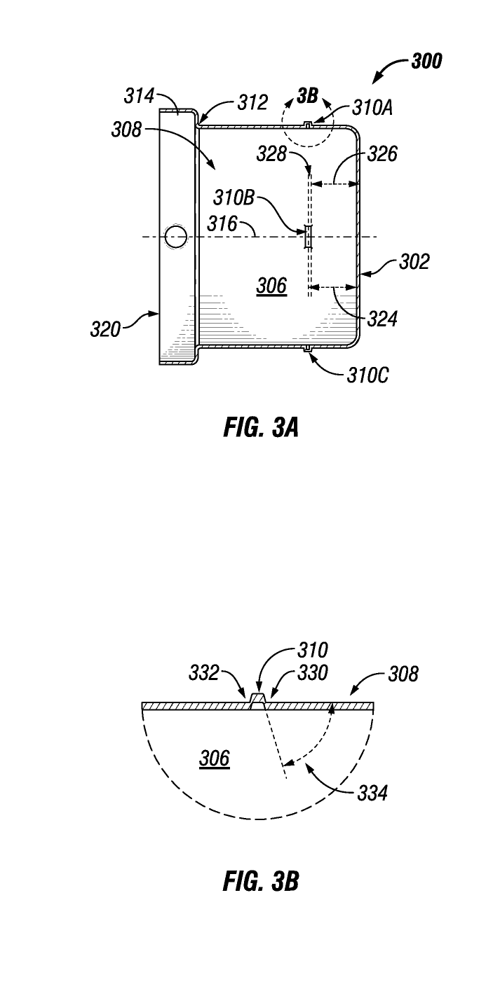

FIG. 3A illustrates a side view of a thread protector plug 300. The thread protector plug 300 can have a base 302 that may be connected to a wall or vertical wall 306. The wall or vertical wall can be connected to a retainer ring 312. The wall or vertical wall 306 may have an outer surface 308, that can have multiple protrusions 310A, 310B, 310C (collectively 310) extending outwardly from the outer surface 308. The retainer ring 314 may be formed, attached, or connected to the wall or vertical wall 306. Along the outer surface of the retainer ring 314, a through hole 316 may be present. The through hole 316 may be utilized to assist in securing a protected material during transport, and/or to further securing the thread protector plug 300 to a protected material. The through hole 316 may also be used to assist in removal or installation. The vertical wall or wall 306, and/or retainer ring 314 may have opening and/or void 320 within the interior of the thread protector plug 300. The opening and/or void 320 may create a hollow void, or an opening to a larger void with the wall(s) or vertical wall(s) 306.

FIG. 3B illustrates an exploded side view of the protrusions 310. The protrusions (collectively 310) can be manufactured or formed along a wall or vertical wall 306, and/or more specifically the outer surface 308 of a vertical wall or wall 306. The protrusions can have a specific shape, cross section, angle, or profile 330 to match the threads or thread pattern of a material or item to be protected. For example, the shape, cross section, angle, or profile 330 of the protrusions may be triangular, square, cuboid, trapezoidal, polygon, rectangular, ellipsoidal, cylindrical, cone, prism, and/or a crescent. The angle of the protrusions 310 relative to an axis of the protector plug 300 can be set to match a particular thread pitch. In addition, there may be a protrusion height 332 to consider as well, in order to match with the thread pattern of a material or item to be protected. For example, a thread pattern may have a depth of one eighth of an inch, the protrusion height 332 could be less than one eighth of an inch or longer if the vertical wall(s) or wall(s) 306 do not interface with the material to be protected. The protrusions 310 can also have specific angular dimensions to match with the thread pattern of a material or item to be protected. For example, the protrusions 310 may have an angular dimension such as, but not limited to, 75.6 degrees plus or minus 0.5 degrees measured from the wall or vertical wall 306. It would be understood that the angular dimension could be small or larger depending on the shape, cross section, or profile of the protrusions 310.

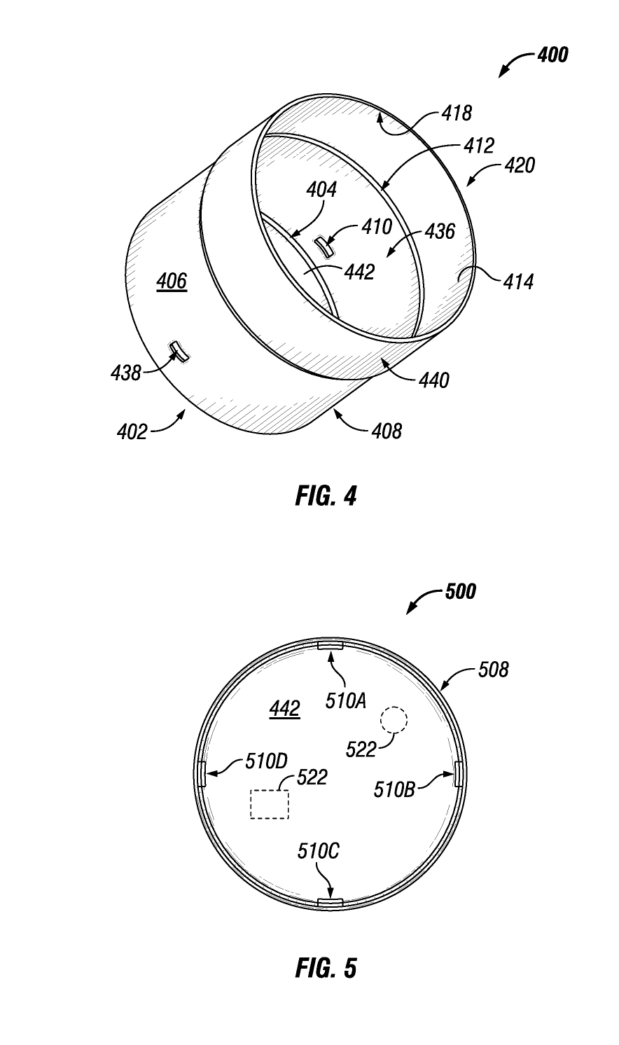

FIG. 4 illustrates a perspective view of a thread protector cap 400. Much like the thread protector plug, all of the discussion of the thread protector plug may also apply to a thread protector cap 400, or vice-versa. The thread protector cap 400, may in one embodiment be, but is not limited to, a circular or cylinder shape or profile. The thread protector cap 400 is configured to protect materials with male thread patterns, or thread patterns along an external or outer surface. When placed over a material, or end of materials to be protected, the thread protector cap 400 can engage with the male threads or thread pattern of the material. The thread protector cap 400 may have a base 402 that can be connected to a vertical wall or walls 406. The connection between the vertical wall or walls 406 and the base 402 can be a result of, but not limited to, a one piece construction of the thread protector cap 400 or may be the result of an adhesion, or welding process. The connection between the vertical walls or wall 406 may also be a rounded edge 404 that can be formed during a bending, molding, manufacture, or created from a welding or adhesion seam.

The vertical wall or walls 406, may have an external or outwardly facing surface 408, and/or an internal or inwardly facing surface 436. The surfaces 408 and/or 436 may have multiple sections, protrusions, indentions, or other surface, profile or shape modifications can be present along the surfaces. For example, the thread protector cap 400 may have a containment ring 412, a retainer ring 414, protrusions (collectively 410), indentions (collectively 438) and/or an opening 420.

The containment ring 412 may be in one embodiment a lip or ring that can link, connect, or engage with a lip or ring or edge of the material to be protected. The retainer ring 414 in one embodiment may be an extension of the vertical walls or wall 406 to cover more of a material to be protected. The protrusions 410 can be configured to match the dimensions of a thread pattern, such as, but not limited to, form of the threads (cross sectional shape or threadform), angle or thread angle, lead, pitch, starts, major diameter, minor diameter, and/or pitch diameter. Similarly, the indentions can be the inversion of the protrusions, configured to match the dimensions of a thread pattern, such as, but not limited to, form of the threads (cross sectional shape or threadform), angle or thread angle, lead, pitch, starts, major diameter, minor diameter, and/or pitch diameter. The opening 420 can allow the thread protector cap 400 to slide onto or over a material to be protected. The retainer ring 414, can have an internal surface 418, and/or an external surface 440. The base 402 may have an external (not shown) and internal surface 442 to completely enclose the base 402.

FIG. 5 illustrates a top view of a thread protector cap 500. The thread protector cap 500 may have protrusions 510A, 510B, 510C, 510D (collectively 510) spaced along an inner surface of the thread protector cap 500. In one embodiment of the present disclosure, the protrusions 510 can be evenly spaced along a perimeter of the internal surface 536 of the vertical wall or walls 506. There may also be corresponding indentions evenly spaced along the outer surface 508 of the vertical wall or walls 506. The bottom surface 542 of a thread protector cap 500 can have, in one embodiment, recesses or vents 522 to allow for over pressures or explosive forces to escape from the material to be protected.

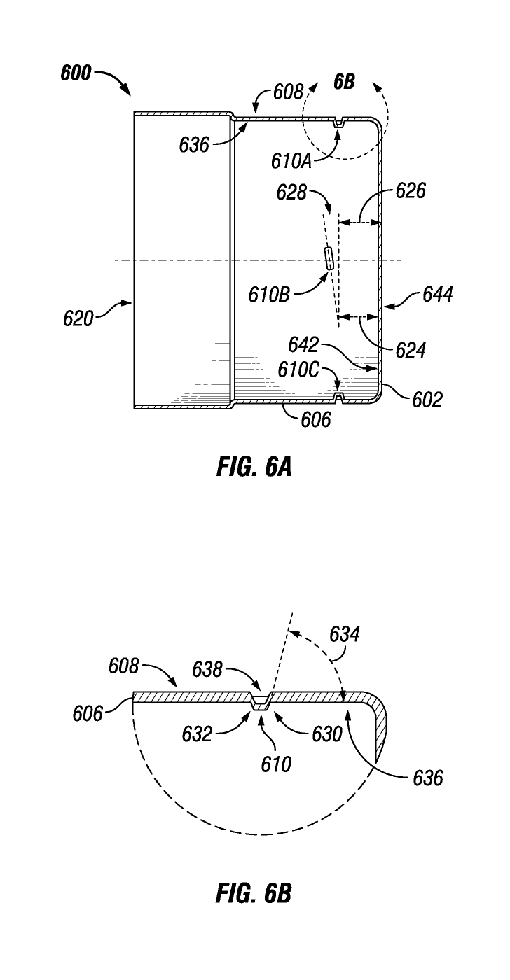

FIG. 6A illustrates a side view of a thread protector cap 600. The thread protector cap 600 may have a base 602, with a bottom outer or outwardly facing surface 644, and an inner or inwardly facing surface 642. The base 602 can be connected to a vertical wall or walls 606, which may have an outer or outwardly facing surface 608, and/or an inner or inwardly facing surface 636. The inner surface 636 of the vertical wall or walls 606 can have protrusions 610A, 610B, 610C, 610D (collectively 610) extending inwardly from the inner surface. The protrusions 610 may be evenly spaced around the perimeter or circumference of the inner surface 636. The protrusions 610 may be placed at a fixed height, from the inner surface 642 of the base 602, or the height may vary slightly. For example, in order to match a thread pattern for a material to be protected, the protrusions may be placed at a fixed height, with an offset angle 628. The offset angle 628 is created when the protrusion has a first fixed height 624 from the base 602 at a first end of the protrusion, and a second fixed height 626 from the base 602 at a second end of the protrusion. Alternatively, the offset angle 628 is not perpendicular to an axis through the thread protector 600, and is not parallel to the plane of the base 602. The difference between the two fixed heights generates the offset angle allowing the protrusion to match a thread pattern.

FIG. 6B illustrates an exploded side view of the protrusions 610. The protrusions (collectively 610) are along a wall or vertical wall 606, and/or more specifically the inner surface 636 of a vertical wall 606. The protrusions 610 can have a specific shape or profile 630 to match the threads or thread pattern of a material or item to be protected. In addition, there may be a protrusion height 632 to consider as well, in order to match with the thread pattern of a material or item to be protected. The protrusions 610 can also have specific angular dimensions 634 to match with the thread pattern of a material or item to be protected. The protrusions 610 may also have a corresponding indention 638 along the outer surface 608 of the vertical wall or walls 606.

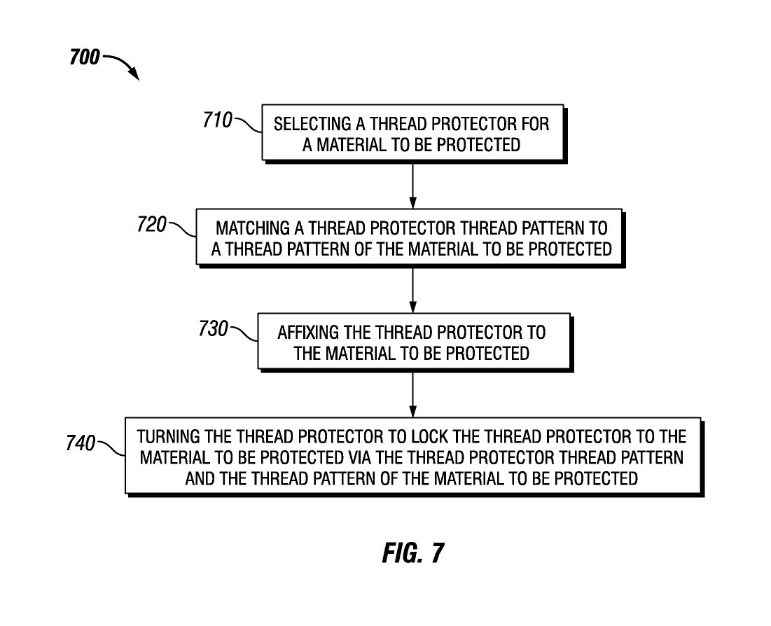

FIG. 7 illustrates a flow chart 700 of a method of use for at least one embodiment of the present invention. Step 710, allows for the selecting of a thread protector for a material to be protected. For example, a thread protector cap or plug would need to be selected for the appropriate versions, protrusions, thread pattern, thickness or other dimensional considerations, and/or combinations thereof. A step 720, illustrates a matching of a thread protector thread pattern to a thread pattern of the material to be protected. The matching of a thread protector thread pattern can include, but is not limited to, matching the protrusions of a thread protector to a thread pattern of a material to be protected. The matching of the protrusions, may include matching a right or left handed thread, a form or cross sectional shape, a specific thread angle, a specific lead, pitch, or number of starts of a thread pattern, or the protrusions themselves.

Step 730, may illustrate affixing the thread protector to the material to be protected. Affixing may include inserting, covering, or enclosing a material to be protected. For example, a thread protector in a plug configuration may be inserted into or enclose a material that needs to be protected, such as, but not limited to, an end of a perforation gun for oil and gas perforation and fracking. In alternative embodiments, such as, but not limited to, a thread protector cap configuration, the thread protector cap may be utilized to cover or enclose a material that needs to be protected, such as but not limited to, a shape charge or a shape charge carrier. In step 740, it may be illustrated that the thread protector can be turned or rotated to lock the thread protector to or with the material to be protected via the thread protector thread pattern and the thread pattern of the material to be protected. The rotation or turning may include rotating or turning the thread protector cap or plug, an eighth, a quarter (ninety degrees), three eighths, a half (one hundred and eighty degrees), or any combination of fractions of a full 360 degree rotation, or may also require more than 360 degrees of rotation. In one embodiment of the present disclosure, the number of turns would be one and one half turns to complete a locking of engaging with the material to be protected. However, in alternative embodiments the number of rotations could be one half turn, one turn, or two turns to complete a locking or engaging.

In alternative embodiments of the present invention, a user may select a thread protector from a thread protector cap or plug configuration. The thread protector cap or plug may have at least one protrusion or as many as desired. The protrusions can be evenly spaced along an outer or inner perimeter, or circumference, or surface of a thread protector cap or plug, and/or may be of various heights, lengths or other dimensions

In one embodiment of the present disclosure, the thread protector caps or plugs can be utilized to enclose a perforation gun and/or cover a shape charge within a perforation gun. Alternative embodiments, may have thread protector caps or plugs may have a major diameter of the thread pattern, but not limited to, 2 and 9/16 inches, or 2 and ⅞ inches. In other embodiments of the present disclosure, the wall(s), base, and/or other sections of the can be as thin as 25 thousandths of an inch, to three inches. The diameter of the thread protector could also range from one half inch, to upwards of 24 inches.

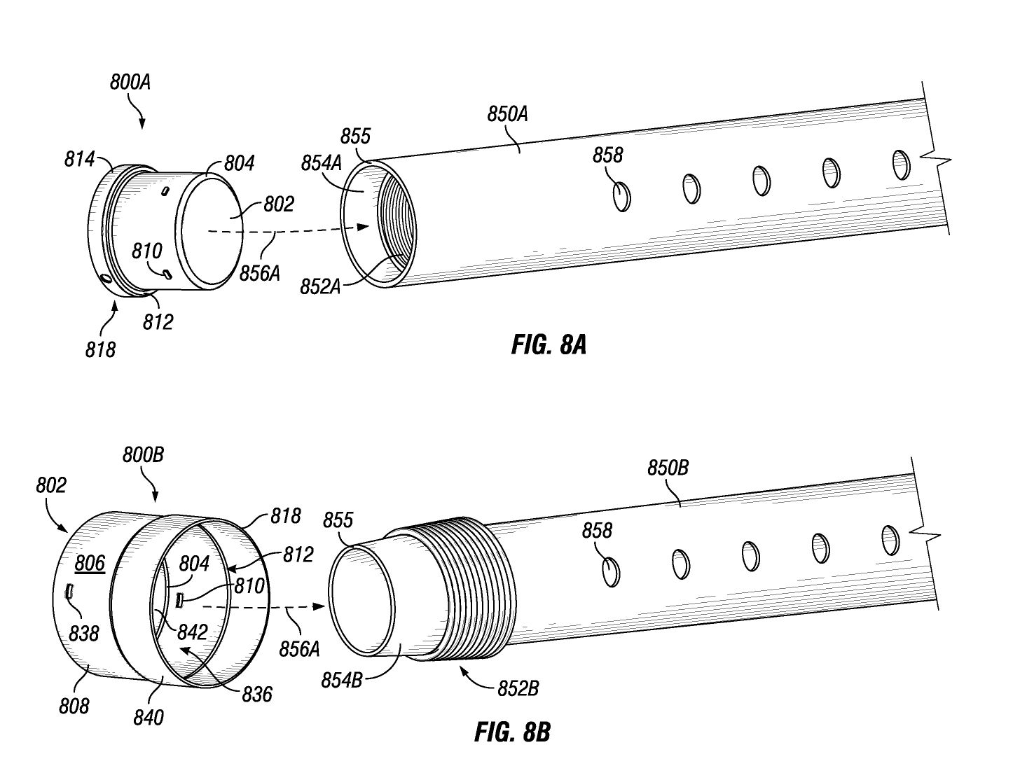

FIGS. 8A and 8B illustrate a thread protector plug 800A and/or a thread protector cap 800B (collectively 800) engaging with a material to be protected. In one embodiment of the present disclosure, the thread protector 800 may, engage with a perforation gun, shape charge carrier, and/or explosive protection carrier 850A, 850B. The thread protector 800 may have a base 802, wherein the base 802 may be connected via a rounded edge 804 to a wall or vertical wall 806. It would be understood that in alternative embodiments of the present disclosure, the base 802 can be directly connected, formed, and/or manufactured with the wall or vertical wall 806. The base 802 may also have an internally facing or inwardly facing surface that can have vents (not shown) or other pass through abilities to assist in reduction of an explosive force. In one embodiment of the present disclosure, the vent and/or the material utilized to make, manufacture, and/or form the thread protector(s) may be of different materials. For example, the vents can be manufactured, made and/or formed with a material that may have a specific melt or destruction value or level to match a specific temperature or pressure threshold. When the pressure or temperature exceed the threshold value or level, the vent material can melt, disintegrate, or self-destruct in a manner to relieve a pressure or internal, or external temperature of the material to be protected. This protection can allow the thread protector to prevent an explosive force, and/or pressure from building up or occurring within the material to be protected.

The wall or vertical wall 806 may have an outer surface 808, and/or an inner surface 836. In one embodiment of the present disclosure, the wall or vertical wall 806 may be perpendicular or 90 degrees from the plane of the base 802, and/or the base 802. It would be understood that in alternative embodiments of the present disclosure, the wall or vertical wall 806 could be at an acute (smaller than 90 degrees) or obtuse (greater than 90 degrees) angle from the base 802, and/or a plane containing the base 802 to match a tapered thread 852B or other surface to be protected. The outer surface 808, and/or the inner surface 836 may have protrusions 810 manufactured, formed, or connected to the corresponding surface 808/836. It would also be understood that in alternative embodiments of the present disclosure, the protrusions 810, may have a corresponding indention 838 on the mirror or opposite surface. For example, for a thread protector plug 800A, the protrusions 810 may face inwardly from the inner surface 836, and a corresponding indention 838 may be found along the outer surface 808. Alternatively, for a thread protector cap 800B, the surfaces could be reversed, or the protrusions 810 may face outwardly from the outer surface 808, and a corresponding indention 838 may be found along the inner surface 836.

The thread protector 800 may also have a connecting ring 812, and/or retainer ring 814. The connecting ring 812 and/or retainer ring 814 may be connected, formed, and/or manufactured with the wall or vertical wall 806. In alternative embodiments of the present disclosure, the connecting ring 812 and/or the retainer ring 814 may have corresponding or integrated weather tight seals and/or o-rings to engage the end 855 of the carrier 850A. The connecting ring 812 and/or the retainer ring 814 may have an outer surface 818, and/or an inner surface 840. These surfaces 818/840 may interface with a material to be protected or also have a protective or sealing coating or material to allow for increased protection and/or weather tight.

One embodiment of the present disclosure, may include the interfacing of the thread protector plug 800A with a perforation gun with internal threads 850A. The perforation gun 850A may have an internal thread pattern 852A and/or an internal recessed or seal area 854A. The internal thread pattern 852A and/or the internal recessed or seal area 854A, can interface and/or engage with the protrusions 810, the outer surface 808 of the wall or vertical wall 806, the containing ring 812, and/or the retainer ring 814. The protrusions 810 can engage with the internal thread pattern 852A to lock and/or secure the thread protector plug 800A with the perforation gun 850A. The recessed or seal area 854 may engage with the outer surface 808 of the wall or vertical wall 806, the containing ring 812, and/or the retainer ring 814, and/or may also interface or engage with a seal or o-ring to provide a weather tight connections. The thread protector plug 800A may be affixed, connected, threaded and/or rotated 856A into the perforation gun 850A in order to secure, enclose, and/or protect the threads and/or explosive materials within the perforation gun.

Alternatively, another embodiment of the present disclosure, may include the interfacing of the thread protector cap 800B with a perforation gun with external threads 850B. The perforation gun 850B may have an external thread pattern 852B and/or an external recessed or seal area 854B. The external thread pattern 852B and/or the external recessed or seal area 854B, can interface and/or engage with the protrusions 810, the inner surface 836 of the wall or vertical wall 806, the containing ring 812, and/or the retainer ring 814. The protrusions 810 can engage with the external thread pattern 852B to lock and/or secure the thread protector cap 800B with the perforation gun 850B. The recessed or seal area 854B may engage with the inner surface 836 of the wall or vertical wall 806, the containing ring 812, and/or the retainer ring 814, and/or may also interface or engage with a seal or o-ring to provide a weather tight connections. The thread protector plug 800B may be affixed, connected, threaded and/or rotated 856B onto the perforation gun 850B in order to secure, enclose, and/or protect the threads and/or explosive materials within the perforation gun.

In alternative embodiments of the present disclosure, the perforation gun(s) 850A/850B and/or the thread protector cap and/or plug can be interfaced in metal to metal manner. In alternative embodiments of the present disclosure that utilize a weather tight seal and/or a o-ring, the seal and/or o-ring may have a groove built into the perforation gun 850 and/or the thread protector 800 that allows for a metal on metal connection, and also a sealing engagement between the perforation gun 850 and thread protector 800. Additionally, the weather tight seal, and/or o-ring may directly interface or through a seal or ring groove with the recessed or seal area 854A/854B, the end piece 855, the inner or outer surface 818, the inner surface 836 of the wall or vertical wall 806, the containing ring 812, and/or the retainer ring 814.

Alternative embodiments of the present disclosure, could also be utilized to enclose and/or protect a shape charge slot or opening 858 along a perforation gun or shape charge carrier. These explosive charges must be enclose and/or encased within metal or glass according to DOT regulations. In one embodiment of the present disclosure, a thread protector 800 can be utilized and/or configured to enclose a shape charge slot or opening 858 to meet DOT requirements. While, alternative embodiments can be utilized and/or configured to enclose and/or secure the ends of a perforation gun.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the disclosure to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A metal protection apparatus comprising:
a base;
a vertical wall connected to the base at a proximal end;
at least one protrusion protruding externally from the vertical wall;
wherein the at least one protrusion is configured to engage a threaded surface and wherein said protrusion is configured near a distal end of the vertical walls such that the metal protection apparatus can be fully engaged with a threaded device in less than two turns.

2. The metal protection apparatus of claim 1, wherein the base and the vertical wall have a thickness of at least 25 thousandths (0.025) of an inch.

3. The metal protection apparatus of claim 1, wherein the vertical wall is connected to a retaining ring.

4. (canceled) The metal protection apparatus of claim 1, wherein the at least one protrusion protrudes externally from the vertical wall.

5. The metal protection apparatus of claim 1, wherein the at least one protrusion protrudes internally from the vertical wall.

6. The metal protection apparatus of claim 1, wherein the at least one protrusion comprises four protrusions.

7. The metal protection apparatus of claim 1, wherein the at least one protrusion is sized to match the pitch of a thread pattern.

8. The metal protection apparatus of claim 3, wherein the retaining ring is connected to the vertical wall and supports an o-ring.

9. The metal protection apparatus of claim 3, wherein the retaining ring is connected to the vertical wall and supports a weather tight seal.

10. The metal protection apparatus of claim 1, wherein the at least one protrusion is evenly spaced along the body of the vertical wall.

11. The metal protection apparatus of claim 1, wherein the at least one protrusion are each placed at a fixed distance distal from the base and the fixed distance is different for each protrusion.

12. An apparatus for thread protection comprising:
a metal material;
a hollow cylinder formed of the metal material having a vertical wall, a first end, and a second end distal from the first end;
an opening on the first end of the hollow cylinder;
a base to enclose the second end of the hollow cylinder distal from the first end of the hollow cylinder; and
at least one protrusion along the vertical wall of the hollow cylinder, wherein said protrusion extends outwardly from the hollow cylinder and is configured near the first end of the hollow cylinder such that the apparatus for thread protection can be fully engaged with a threaded device in less than two turns.

13. (canceled)

14. The apparatus for thread protection of claim 12, wherein the at least one protrusion extend inwardly from the vertical wall of the hollow cylinder.

15. The apparatus for thread protection of claim 12, wherein the at least one protrusion is evenly placed along the circumference of the vertical wall of the hollow cylinder.

16. The apparatus for thread protection of claim 12, wherein the at least one protrusion is created at a fixed distance from the opening on the first end of the hollow cylinder.

17. The apparatus for thread protection of claim 12, wherein the fixed distance for each protrusion is different.

18. The apparatus for thread protection of claim 12, wherein the at least one protrusion each have a first protrusion end, and a second protrusion end distal from the first protrusion end, and the first protrusion end is set a first fixed distance from the base, and the second protrusion end is set a second fixed distance from the base.

19. The apparatus for thread protection of claim 12, wherein the at least one protrusion are matched to a thread pitch pattern.

20. A method of use of a metal protection apparatus comprising the steps:
Selecting a thread protector for a material to be protected;
Matching a thread protector thread pattern to a thread pattern of the material to be protected;
Affixing the thread protector to the material to be protected; and
Turning the thread protector two turns or less to lock the thread protector to the material to be protected via the thread protector thread pattern and the thread pattern of the material to be protected.

21. The method of use of a metal protection apparatus of claim 20 wherein the thread protector may be selected from a thread protector cap or a thread protector plug.

22. The method of use of a thread protector of claim 20 wherein the thread protector thread pattern further comprises at least one protrusion.

23. The method of use of a metal protection apparatus of claim 20 wherein the matching step further comprises matching the pitch of a thread protector thread pattern to the pitch of the thread pattern of the material to be protected.

24. The method of use of a metal protection apparatus of claim 20 wherein the affixing step further comprises inserting a thread protector plug within an opening within the material to be protected.

25. The method of use of a metal protection apparatus of claim 20 wherein the affixing step further comprises covering a material to be protected with a thread protector cap.

26. The method of use of a metal protection apparatus of claim 20 further comprises enclosing at least one end of a perforation gun.

27. The method of use of a metal protection apparatus of claim 20 wherein the method further comprises enclosing at least one shape charge.
